(19) United States
(12) Patent Application Publication
(10) Pub. No.: US 2021/0264209 A1
(43) Pub. Date: Aug. 26, 2021

(54) METHOD FOR GENERATING ANOMALOUS DATA

(71) Applicant: MakinaRocks Co., Ltd., Seoul (KR)

(72) Inventors: Ki Hyun KIM, Yongin-si (KR); Hooncheol SHIN, Seoul (KR)

(21) Appl. No.: 17/182,996

(22) Filed: Feb. 23, 2021

(30) Foreign Application Priority Data
Feb. 24, 2020 (KR) 10-2020-0022587

(51) Int. Cl. G06K 9/62; G06N 3/04; G06N 3/08

(52) U.S. Cl. CPC G06K 9/6257; G06K 9/6265; G06N 3/08; G06N 3/049

(57) ABSTRACT

Disclosed is a non-transitory computer readable medium storing a computer program. When the computer program is executed by one or more processors of a computer device, the computer program causes one or more processes to perform the following operations for data processing, and the operations may include: calculating a first probability distribution and a first sample statistical amount for a first sample data set; training a pseudo anomaly generation model that learns a second probability distribution and a second sample statistical amount for a second sample data set; and generating a training data set based on the pseudo anomaly generation model.

### CROSS-REFERENCE TO RELATED APPLICATIONS

This application claims priority to and the benefit of Korean Patent Application No. 10-2020-0022587 filed in the Korean Intellectual Property Office on Feb. 24, 2020, the entire contents of which are incorporated herein by reference.

### BACKGROUND

### Technical Field

The present disclosure relates to machine learning, and particularly, to a method for generating appropriate anomalous data in order to train a neural network.

### Description of the Related Art

In machine learning, it is important to secure a set of good training data. In a model that detects an anomaly, a good training data set should include an appropriate number of anomalous data which are as similar as possible to normal data or closest to the normal data in terms of an anomaly classification criterion.

Data obtained from sensors in factories may generally include very little anomaly. When the machine learning is performed by using the data as training data, classification performance of the model may be significantly degraded.

Therefore, in order to secure the appropriate number of anomalous data for the training data, there is a technical demand for artificially generating the anomalous data.

### BRIEF SUMMARY

One or more embodiments of the present disclosure provides a method for generating anomalous data.

However, technical benefits of the present disclosure are not restricted to the benefits mentioned as above. Unmentioned technical benefits will be apparently appreciated by those skilled in the art by referencing to the following description.

An embodiment of the present disclosure provides a non-transitory computer readable medium storing a computer program. When the computer program is executed by one or more processors of a computer device, the computer program causes one or more processes to perform a method for data processing, and the method may include: calculating a first probability distribution and a first sample statistical amount for first data by using the first data set; training a pseudo anomaly generation model that learns a second probability distribution and a second sample statistical amount for the first data; and generating a training data set based on the pseudo anomaly generation model.

The first sample data set and the second sample data set may be vectors or scalars for homogenous data.

The training of the pseudo anomaly generation model may include calculating an inter-distribution similarity between the first probability distribution and the second probability distribution, and determining whether to additionally perform the training of the pseudo anomaly generation model based on the inter-distribution similarity.

The determining of whether to additionally perform the training of the pseudo anomaly generation model based on the inter-distribution similarity may include determining to additionally perform the training of the pseudo anomaly generation model when the inter-distribution similarity is equal to or less than a preset first reference.

The method may further include: determining to terminate the training of the pseudo anomaly generation model when the inter-distribution similarity is equal to or more than the preset first reference; and determining a sample statistical amount of a probability distribution derived from the pseudo anomaly generation model for which training is terminated as the second sample statistical amount.

The training of the pseudo anomaly generation model may include determining a candidate sample statistical amount, and determining the candidate sample statistical amount as the second sample statistical amount based on a significance probability of at least one data value of data values included in the candidate sample statistical amount.

The candidate sample statistical amount may be determined based on extracted noise and the first sample statistical amount.

The noise may be extracted from a normal distribution.

The determining of the second sample statistical amount may include determining the candidate sample statistical amount as the second sample statistical amount when the significance probability of a first data value included in the candidate sample statistical amount exceeds a preset reference.

The first sample data set and the training data set may include time-series data, and the pseudo anomaly generation model may be a neural network that can process the time series data. For instance, a recurrent neural network (RNN) can be one of examples of the pseudo anomaly generation model.

The method may further include: performing the evaluation for the training data set.

The performing of the evaluation for the training data set may include generating a data subset for the training data set, inputting each of the data included in the data subset into the anomaly classification model and mapping the input data to a resolution space, and calculating suitability of the training data set based on the data included in the data subset and a classification reference of the anomaly classification model.

The suitability may be based on at least one of a distance of each of the data included in the training data set from the classification reference, a ratio of anomalous data of the training data set, density of the data included in the training data set, or a dispersion of a distance of each of the data included in the training data set from the classification reference.

The suitability may be a reciprocal of at least one of: a distance of each of the data included in the training data set from the classification reference, a ratio of anomalous data of the training data set, density of the data included in the training data set, or a dispersion of a distance of each of the data included in the training data set from the classification reference.

Another embodiment of the present disclosure provides a computing device for data processing. The computing device may include: a processor; and a memory, in which the processor may be configured to calculate a first probability distribution and a first sample statistical amount for a first sample data set, train a pseudo anomaly generation model that learns a second probability distribution and a second sample statistical amount for the first sample data set, and generate a training data set based on the pseudo anomaly generation model.

Technical solving means which can be obtained in the present disclosure are not limited to the aforementioned solving means and other unmentioned solving means will be clearly understood by those skilled in the art from the following description.

According to an embodiment of the present disclosure, a method for generating anomalous data similar to normal data can be provided.

Effects which can be obtained in the present disclosure are not limited to the aforementioned effects and other unmentioned effects will be clearly understood by those skilled in the art from the following description.

### BRIEF DESCRIPTION OF THE SEVERAL VIEWS OF THE DRAWINGS

Various aspects are now described with reference to the drawings and like reference numerals are generally used to designate like elements. In the following embodiments, for the purpose of description, multiple specific detailed matters are presented to provide general understanding of one or more aspects. However, it will be apparent that the aspect(s) can be executed without the detailed matters.

FIG. 1 is a block diagram illustrating a configuration of a computing device for generating anomalous data according to some embodiments of the present disclosure.

FIG. 2 is a diagram illustrating an example of a neural network according to some embodiments of the present disclosure.

FIG. 3 is a diagram illustrating a recurrent neural network (RNN) according to some embodiments of the present disclosure.

FIG. 4 is a flowchart illustrating a process of generating anomalous data by a processor according to some embodiments of the present disclosure.

FIG. 5 is a flowchart illustrating a process of training a pseudo anomaly generation model by a processor according to some embodiments of the present disclosure.

FIG. 6 is a flowchart illustrating a process of training a pseudo anomaly generation model by a processor according to some embodiments of the present disclosure.

FIG. 7 is a flowchart illustrating a process of performing evaluation for a training data set by a processor according to some embodiments of the present disclosure.

FIG. 8 is a simple and normal schematic view of a computing environment in which the embodiments of the present disclosure may be implemented.

### DETAILED DESCRIPTION

Various embodiments will now be described with reference to drawings. In the present specification, various descriptions are presented to provide appreciation of the present disclosure. However, it is apparent that the embodiments can be executed without the specific description.

“Component”, “module”, “system”, “unit” and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

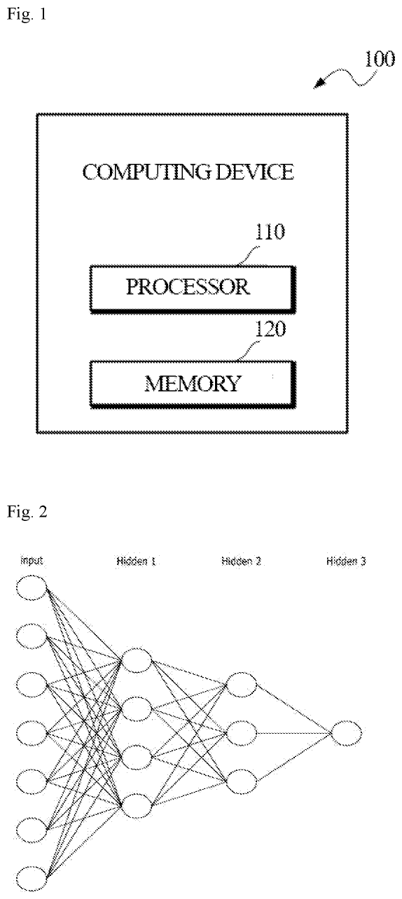

FIG. 1 is a block diagram illustrating a configuration of a computing device for generating anomalous data according to some embodiments of the present disclosure.

A configuration of the computing device 100 illustrated in FIG. 1 is only an example shown through simplification. In an embodiment of the present disclosure, the computing device 100 may include other components for performing a computing environment of the computing device 100 and only some of the disclosed components may constitute the computing device 100.

The computing device 100 may include a processor 110 and a memory 120.

The processor 110 may be constituted by one or more cores and may include processors for data analysis and deep training, which include a central processing unit (CPU), a general purpose graphics processing unit (GPGPU), a tensor processing unit (TPU), and the like of the computing device. The processor 110 may read a computer program stored in the memory 120 to perform data processing for generating pseudo anomalous data according to an embodiment of the present disclosure. According to an embodiment of the present disclosure, the processor 110 may perform a calculation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, the CPU and the GPGPU may together process the learning of the network function and data classification using the network function. Further, in an embodiment of the present disclosure, processors of a plurality of computing devices may be used together to process the learning of the network function and the data classification using the network function. Further, the computer program executed in the computing device according to an embodiment of the present disclosure may be a CPU, GPGPU, or TPU executable program.

According to an embodiment of the present disclosure, the memory 120 may store arbitrary type of information generated by the processor 110.

According to an embodiment of the present disclosure, the memory 120 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The description of the memory is just an example and the present disclosure is not limited thereto.

FIG. 2 is a diagram illustrating an example of a neural network according to some embodiments of the present disclosure.

Throughout the present specification, a computation model, the neural network, a network function, and the neural network may be used as an interchangeable meaning. The neural network may be generally constituted by an aggregate of calculation units which are mutually connected to each other, which may be called a node. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of the output node may be determined based on data input in the input node. Here, a node connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be configured to include one or more nodes. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which other input nodes connected through the links do not have. Similarly thereto, the final output node may mean one or more nodes which do not have the output node in the relationship with other nodes among the nodes in the neural network. Further, a hidden node may mean not the initial input node and the final output node but the nodes constituting the neural network. In the neural network according to an embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another embodiment of the present disclosure, the number of nodes of the input layer may be smaller than the number of nodes of the output layer, and the neural network may be a neural network of a type in which the number of nodes decreases from the input layer to the hidden layer. Further, in the neural network according to still another embodiment of the present disclosure, the number of nodes of the input layer may be larger than the number of nodes of the output layer, and the neural network may be a neural network of a type in which the number of nodes increases from the input layer to the hidden layer. The neural network according to yet another embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, potential structures of photos, text, video, voice, and music (e.g., what objects are in the picture, what the content and feelings of the text are, what the content and feelings of the voice are) may be determined. The deep neural network may include a convolutional neural network, a recurrent neural network (RNN), an auto encoder, generative adversarial networks (GAN), a restricted Boltzmann machine (RBM), a deep belief network (DBN), a Q network, a U network, a Siam network, and the like. The description of the deep neural network described above is just an example and the present disclosure is not limited thereto.

In an embodiment of the present disclosure, the network function may include the auto encoder. The auto encoder may be a kind of neural network for outputting output data similar to input data. The auto encoder may include at least one hidden layer and odd hidden layers may be disposed between the input and output layers. The number of nodes in each layer may be expanded symmetrical to reduction in number of nodes from the input layer to an intermediate layer called a bottleneck layer (encoding), and then reduction from the bottleneck layer to the output layer (symmetrical to the input layer). In this case, in the example of FIG. 2, it is illustrated that the dimension reduction layer and the dimension reconstruction layer are symmetric, but the present disclosure is not limited thereto and the nodes of the dimension reduction layer and the dimension reconstruction layer may be symmetric or not. The auto encoder may perform non-linear dimensional reduction. The number of input and output layers may correspond to the number of sensors remaining after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, and semi supervised learning. Learning of the neural network is to reduce or minimize errors in output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (e.g., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (e.g., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (e.g., data to be processed using the learned neural network) of actual data, and as a result, there may be a learning cycle in which errors for the learning data decrease, but the errors for the actual data increase. Overfitting is a phenomenon in which the errors for the actual data increase due to excessive learning of the learning data. For example, a phenomenon in which a neural network that learns a cat by showing a yellow cat does not recognize that the cats other than the yellow cat are the cats may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, etc., may be applied.

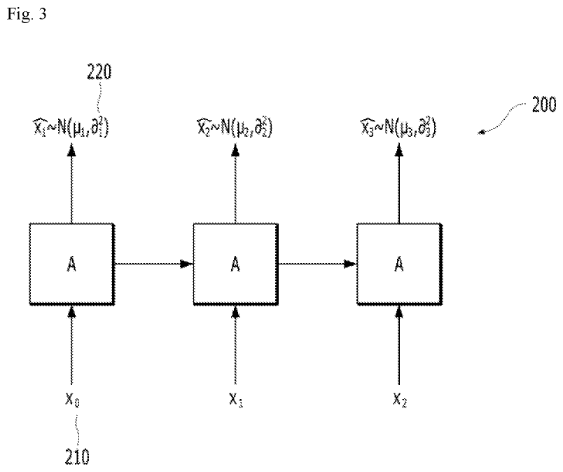

FIG. 3 illustrates an example of a recurrent neural network which is a form of an artificial neural network according to the present disclosure.

As illustrated in FIG. 3, in the present disclosure, a neural network 200 may have a recurrent neural network (RNN) type in addition to a type of a general artificial neural network. The recurrent neural network has a characteristic that a connection between units has a recurrent structure. Such as structure makes it possible to store a state in a neural network so as to model a time-varying dynamic feature. Unlike a forward delivery neural network, the recurrent neural network may process a sequence type input by using an internal memory. Accordingly, the recurrent neural network may process data having time-varying characteristics such as handwriting recognition or speech recognition. The description of the aforementioned data is just an example and the present disclosure is not limited thereto.

Input data 210 according to the present disclosure may be data input into a neural network and in particular, when the neural network 200 is the recurrent neural network, the input data 210 may be sequence data.

According to the present disclosure, output data 220 as a result derived when the input data passes through the artificial neural network may be data expressing the probability distribution. For example, the output data 220 may include a type (e.g., normal distribution) of a distribution and a parameter (e.g., mean) of a first sample data set or a training data set derived by the neural network.

Referring to FIG. 3, when the input data 210 is input into the recurrent neural network, the output data 220 is calculated as a result of the input. Further, as illustrated in FIG. 3, when a neural network 200 takes the form of the recurrent neural network, a unit of the recurrent neural network may affect the calculation of a next unit.

For example, it is assumed that the output data 220 represents a probability distribution for a temperature detected by a sensor at a specific time point. When the temperature at the previous time point is input to the recurrent neural network A as the input data 210, the output data 220 may represent the probability distribution of the temperature at the specific time point. In this case, the probability distribution may be expressed by using data of the type of distribution (e.g., normal distribution) and parameters thereof (e.g., mean and standard deviation of the distribution).

The RNN is generally suitable for modeling of sequence/time-series data. Accordingly, the input data 210 and the output data 220 may be related to text or voice sentences, temperature data over time, and the like. This is only an example of the type of sequence/time series data, and the type of sequence/time series data is not limited thereto.

That is, it is assumed that the input data 210 and the output data 220 are image data. In this case, specific image data (e.g., MNIST data) may be converted into sequence data, and as a result, the input data 210 and the output data 220 may be related to the image data.

Since the aforementioned contents are just examples for the types of input data and output data, the input data and the output data are not limited to the aforementioned examples.

Disclosed is a computer readable medium storing the data structure according to an embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user thinks. The physical relationship between data elements may include an actual relationship between data elements physically stored on a computer-readable storage medium (e.g., hard disk). The data structure may specifically include a set of data, relationships between data, and functions or commands applicable to the data. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a manner that each data is connected in a row with a pointer. In the connection list, the pointer may include connection information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data arrangement structure that may access data limitedly and unlike a stack, the queue may be a data structure (FIFO-First in First Out) in which early stored data is output first. The deck may be a data structure capable of processing data at both ends of the data structure.

The nonlinear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout the present specification, a computation model, the neural network, a network function, and the neural network may be used as the same meaning. (Hereinafter, the computation model, the neural network, the network function, and the neural network will be integrated and described as the neural network). The data structure may include the neural network. In addition, the data structures, including the neural network, may be stored in a computer readable medium. The data structure including the neural network may also include data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data input to the neural network, weights of the neural network, hyper parameters of the neural network, data obtained from the neural network, an active function associated with each node or layer of the neural network, and a loss function for training the neural network or an arbitrary combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include data input into the neural network or data output from the neural network. The data structure including the data input into or output from the neural network may be stored in the computer readable medium. The data structure stored in the computer readable medium may include data input in a neural network inference process or output data output as a result of the neural network inference. In addition, the data structure may include data processed by a specific data processing method, and thus may include data before and after processing. Therefore, the data structure may include data to be processed and data processed through a data processing method.

The data structure may include weights of the neural network (weights and parameters may be used as the same meaning in the present disclosure). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the parameters set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Therefore, it is assumed that the above-described weights and/or combinations of respective weights are included in the data structure including the weights of the neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconstructed in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

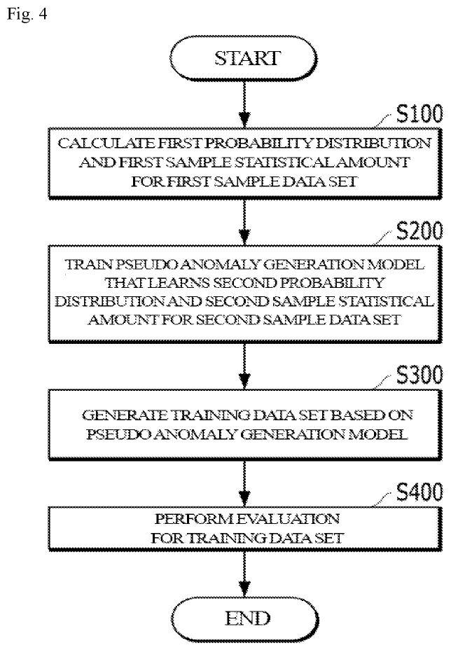

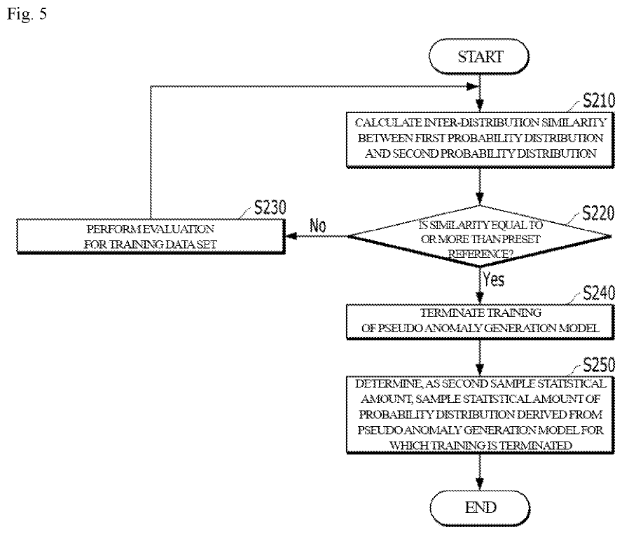

FIG. 4 is a flowchart illustrating a process of generating anomalous data by a processor according to some embodiments of the present disclosure.

Referring to FIG. 4, the processor 110 may calculate a first probability distribution for a first sample data set and a first sample statistical amount of the first probability distribution (S100).

The first probability distribution corresponds to the output data 220 of FIG. 3.

For example, the first sample data set may be a temperature sensed by a sensor at a specific time point, a word appearing when an arbitrary sentence sequence is given, and the like. In this case, the probability distribution of the temperature and the word corresponds to the output data 220.

The first probability distribution and the first sample statistical amount may be calculated through statistical analysis for the first sample data set. Alternatively, the processor 110 allows the neural network to learn the distribution of the first sample data set to calculate the first probability distribution and the first sample statistical amount.

The first sample data set may include the input data 210 and a label of the input data. When the pseudo anomaly generation model is learned by using semi-supervised learning or unsupervised learning, the first sample data set may not include the label for the input data.

The first probability distribution may be used to determine a similarity with a second probability distribution derived from the pseudo anomaly generation model to be generated later, or to determine whether a parameter of the probability distribution derived from the pseudo anomaly generation model is statistically significant.

The first sample data set may be constituted by data randomly extracted from the existing data set. The first sample data set may be constituted by data extracted from the existing data set by a random scheme. For example, the first sample data set may be constituted by data extracted to maintain characteristics of the existing data set.

The details will be described below.

Referring to the contents of FIG. 3 described above, the first probability distribution may be an example of the output data 220 derived by the recurrent neural network A trained by the first sample data set.

The first probability distribution may be a distribution of the first sample data set. The first probability distribution may be expressed by the form of the distribution and the first sample statistical amount of the first probability distribution.

Here, for example, the sample statistical amount may include, for example, a mean, a standard deviation, a mode, a median, etc., of the probability distribution. This is just an example for the sample statistical amount and the form of the sample statistical amount is not limited thereto.

The processor 110 may train the pseudo anomaly generation model that learns a second probability distribution for the second sample data set and a second sample statistical amount of the second probability distribution (S200).

The second sample data set may include homogeneous data to the first sample data set. That is, when the first sample data set is a set of temperature data detected by the sensor for a predetermined time period, the second sample data set may also be a set of temperature data detected by the sensor for the same time period. The first sample data set and the second sample data set may or may not share some or all of the data.

The second probability distribution, as a probability distribution learned by the pseudo anomaly generation model using the second sample data set as a training data set, may be an example of the output data 220 of FIG. 3.

That is, when the pseudo anomaly generation model is, for example, the recurrent neural network of FIG. 3, the output data 220 may be the second probability distribution. In this case, the second probability distribution may be expressed by the form of the distribution and the second sample statistical amount.

As described above, the second sample statistical amount may include a mean, a standard deviation, a mode, a median, etc., of the second probability distribution. However, this is just an example for the second sample statistical amount and the form of the second sample statistical amount is not limited thereto.

The pseudo anomaly generation model according to the present disclosure may be defined as a neural network that generates pseudo anomaly based on the second probability distribution (and second sample statistical amount). Further, the pseudo anomaly generation model according to the present disclosure may be a generative model based on the probability distribution.

The generative model is a model that learns the probability distribution of the output data. That is, the generative model may be a model that learns characteristics of data through the data to derive the probability distribution of the data as an output thereof. Additionally, the generative model may generate data similar to learning data based on the derived probability distribution.

Accordingly, for example, when the second sample data set is temperature data of an apparatus detected by a sensor during a specific time period, the pseudo anomaly generation model may learn a probability distribution of temperature values of the apparatus over time. Once the probability distribution is learned, the processor 110 may generate the temperature value of the apparatus over time based on the learned probability distribution.

The pseudo anomaly according to the present disclosure may mean abnormal data artificially generated based on the input data.

As described above, after learning the probability distribution of the existing collected sample data set, the pseudo anomaly may be generated based thereon. Therefore, anomalous data similar to a pattern of actual data may be generated as compared with the pseudo anomalies which are randomly generated.

The anomalous data generated through the pseudo anomaly generation model may include multiple abnormal data close to the normal data. Therefore, the pseudo anomaly generation model may be more accurately trained with a classification reference between the normal data and the abnormal data.

The processor 110 may generate the training data set based on the trained pseudo anomaly generation model (S300).

The processor 110 may generate the training data set based on the pseudo anomaly generation model. The generated training data set may be used for training the neural network model for detecting anomaly. For example, the generated pseudo anomalous data may be used for validation of the neural network model.

The processor 110 may perform evaluation for suitability for the training data set (S400).

The appropriate training data set may mean a data set including a lot of data close to the classification reference, a data set including anomalous data of an appropriate proportion, a data set in which density of training data and a dispersion of distances between the training data and the classification references are low, etc., for example.

That is, the training data set may be evaluated based on at least one of a distance index (e.g., average distance) between the training data and the classification references, a ratio of the anomalous data among the training data (e.g., when a ratio of the anomalous data and the normal data is 5:5, the ratio may be evaluated as an appropriate ratio), and a dispersion index (e.g., variance) of distances of respective training data up to the classification references. However, since they are just examples of the index for evaluating the training data set, a reference for evaluating the training data set is not limited to the aforementioned contents.

As described above, it may be compared which data set is most suitable among training data sets generated based on various sample statistical amounts. The pseudo anomaly generation model may be trained based on a probability distribution that generates the most suitable training data set and a sample statistical amount thereof. The processor 110 may generate the training data set by the generative model. The performance of the neural network model for anomaly detection may be enhanced based on the training data set.

FIG. 5 is a flowchart illustrating a process of training a pseudo anomaly generation model by a processor according to some embodiments of the present disclosure.

Referring to FIG. 5, the processor 110 may calculate the similarity between the first probability distribution and the second probability distribution (S210).

In regard to the first data, the first probability distribution and the first sample statistical amount according to the present disclosure correspond to the output data 220 derived by the recurrent neural network A trained by the first sample data set. Further, the second probability distribution according to the present disclosure as a probability distribution derived by the pseudo anomaly generation model trained from the second sample data set may correspond to the output data 220 of FIG. 3.

A similarity between distributions according to the present disclosure may be defined as a value obtained by quantifying the similarity between two probability distributions. A concrete definition of the similarity between distributions may vary depending on a derivation scheme.

For example, the processor 110 may calculate the similarity between distributions based on a difference in mean and standard deviation value between two probability distributions. Alternatively, the processor 110 may use Kullback-Leibler divergence (KLD) to calculate the similarity between distributions. However, since this is just an example of a method of calculating the similarity between distributions, a method of calculating the similarity between distributions is not limited thereto.

As the similarity between the first probability distribution and the second probability distribution increases, the training data set generated by the pseudo anomalous data set may become similar to the first sample data set. As the similarity between the first probability distribution and the second probability distribution decreases, the difference between the data included in the training data set generated by the pseudo anomalous data set and the data included in the first sample data set may be larger.

The processor 110 may determine whether the similarity is equal to or more than a preset reference. When the similarity is not equal to or more than the preset reference (No in S220), the processor 110 may additionally perform training of the pseudo anomaly generation model (S230).

A goal of the pseudo anomaly generation model according to the present disclosure is to better generate anomalous data close to the classification reference, e.g., similar to the normal data. Accordingly, in some embodiments, the processor 110 may maintain the similarity between the probability distribution derived from the pseudo anomaly generation model and the first probability distribution at an appropriate level.

Therefore, in training the pseudo anomaly generation model, if the similarity between the second probability distribution and the first probability distribution derived from the current pseudo anomaly generation model is equal to or more than a preset reference, training may be performed no longer. By such a scheme, it is possible to prevent the result that the pseudo anomaly generation model is overtrained so that the first probability distribution and the second probability distribution become the same.

On the contrary, when the similarity does not meet the preset reference, in some embodiments, it may be necessary to additionally perform the training of the pseudo anomaly generation model.

When the similarity is equal to or more than the preset reference (Yes in S220), the processor 110 may terminate the training of the pseudo anomaly generation model (S240).

The aforementioned preset reference may vary depending on a field to which the pseudo anomaly generation model is applied is applied, a data format, a data type, and the like according to the present disclosure.

The processor 110 may determine the sample statistical amount of the probability distribution derived from the pseudo anomaly generation model for which training is terminated as the second sample statistical amount (S250).

As described above, the second sample statistical amount may include a mean, a standard deviation, a mode, a median, etc., of the second probability distribution. However, this is just an example for the second sample statistical amount and the form of the second sample statistical amount is not limited thereto.

As described above, the processor 110 may obtain a plurality of second sample statistical amounts meeting the preset reference. Therefore, the processor 110 may evaluate the training data set generated based on each of the second sample statistical amounts by a method to be described later. The training data is generated from the pseudo anomaly generation model that generates the most appropriate anomalous data based on the evaluation to more effectively perform training of the anomaly detection model.

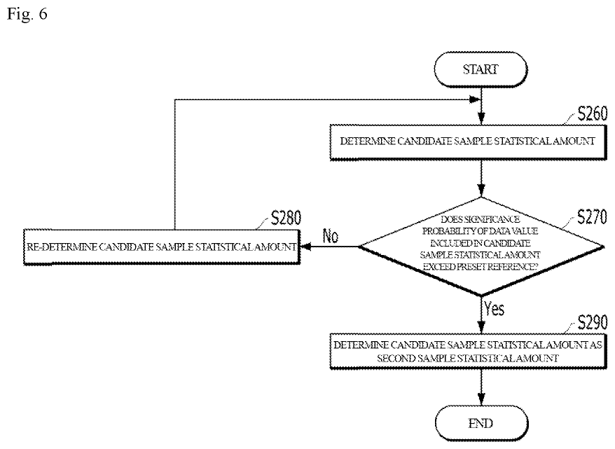

FIG. 6 is a flowchart illustrating a process of training a pseudo anomaly generation model by a processor according to some embodiments of the present disclosure.

Referring to FIG. 6, the processor 110 may determine a candidate sample statistical amount (S260).

The candidate sample statistical amount according to the present disclosure may be a sample statistical amount approximated based on a first sample statistical amount.

Such a candidate sample statistical amount may be determined experimentally, but may also be generated using extracted random noise.

For specific description, it is assumed that the sample statistical amount includes the mean value and the standard deviation value.

For example, the processor 110 may extract noise a in order to calculate the candidate sample statistical amount. Further, here, the noise a may be extracted from a normal distribution (a may follow the normal distribution). The processor 110 may determine a value acquired by adding values acquired by multiplying the α and the standard deviation value included in the first sample statistical amount by each other to the mean value included in the first sample statistical amount as the mean of the candidate sample statistical amount.

In this case, more candidate sample statistical amounts close to the first sample statistical amount may be calculated, and as a result, the candidate sample statistical amounts approximated to the first sample statistical amount may be more densely examined.

As another example, the processor 110 may recognize the standard deviation value included in the first sample statistical amount. The processor 110 may recognize the mean and a standard deviation (hereinafter, referred to as a second standard deviation) of the standard deviation based on the ‘probability distribution of the standard deviation’ of a sample standard deviation included in the first sample statistical amount.

Based thereon, the processor 110 may determine, as the standard deviation value of the candidate sample statistical amount, a value acquired by multiplying the mean of the standard deviation by a or a value acquired by adding a value acquired by multiplying the second standard deviation and a by each other to the mean of the standard deviation.

Since the aforementioned contents are just an example for calculating the candidate sample statistical amount, the calculation method of the candidate sample statistical amount is not limited thereto.

As described above, it is possible to derive the candidate sample statistical amount from all sections in which the candidate sample statistical amount may be positioned without depending on an experimental result. In particular, when a follows the normal distribution, more candidate sample statistical amounts relatively closer to the first sample statistical amount are derived and fewer candidate sample statistical amounts relatively farther from the first sample statistical amount are derived. Accordingly, there is a higher probability of finding a model that is most similar to the first probability distribution and generates the anomaly at an appropriate ratio.

Alternatively, the processor 110 may generate the second probability distribution based on the first probability distribution and the a.

Specifically, the processor 110 may divide a probability density function of the first probability distribution into a plurality of sections. The processor 110 may determine the second probability distribution based on each of the divided probability density functions and the α. The processor 110 may cause the neural network according to the present disclosure to learn the second probability distribution.

For example, in the first probability distribution, the processor 110 may find a first section in which a probability density value is equal to or larger than a preset reference and a second section that is a section excluding the first section.

The processor 110 may find a probability density function in each of the first section and the second section.

The processor 110 may determine, as the probability density function of the second probability distribution, a linear combination of a value acquired by multiplying the probability density function of the first section by the α and a value acquired by multiplying the probability density function of the second section by (1−α).

The processor 110 may cause the neural network to learn the second probability distribution corresponding to the probability density function determined as above.

As such, generating the second probability distribution by dividing the first probability distribution based on the probability density is just an example for generating the second probability distribution based on the probability density function of the first probability distribution.

The processor 110 may determine whether a significance probability of a data value included in the candidate sample statistical amount exceeds a preset reference (S270).

Statistical hypothesis testing, as one of the statistical assumptions, may principally refer to a process of determining reasonableness of a hypothesis using information on a sample in relation to a claim that a population distribution has a predetermined parameter value. The significance probability in the statistical hypothesis testing may be defined as a probability that a more extreme result than a result acquired when assuming that a null hypothesis is correct will be actually observed. In this case, the null hypothesis may mean a statistical hypothesis which becomes an object to be validated.

As an example, in the present disclosure, the processor may infer the validity of the candidate sample statistical amount through the statistical hypothesis testing. For example, it is assumed that the mean of the first sample statistical amount corresponding to the mean of the population distribution is 0 and the mean value included in the candidate sample statistical amount is 3. In this case, in the case of one-sided validation, the significance probability may mean a probability that a sample mean of a randomly extracted sample group will be larger than the candidate sample statistical amount of 3. However, this is just an example for the method for deriving the significance probability for the candidate sample statistical amount and the method for driving the significance probability is not limited thereto.

The preset reference of the significance probability may be experimentally determined. Alternatively, the processor 110 may determine that the candidate sample statistical amount is inappropriate when the significance probability is smaller than 0.05 or smaller than 0.01.

However, this is just an example for the reference of the significance probability and a level of the significance probability which is the preset reference is not limited thereto.

As described above, since the calculated candidate sample statistical amount may be derived from the population distribution (or the first probability distribution), whether a predetermined level of similarity may be guaranteed may be determined in advance by the statistical scheme. Therefore, a calculation process for a candidate sample statistical amount which has an excessively low similarity to the first sample statistical amount and the training data set may be skipped.

When the significance probability does not exceed the preset reference (No in S270), the processor 110 may re-determine the candidate sample statistical amount (S280).

The method for re-determining the candidate sample statistical amount may be the same as the method for determining the candidate sample statistical amount.

When the significance probability exceeds the preset reference (Yes in S270), the processor 110 may determine the candidate sample statistical amount as the second sample statistical amount (S290).

The second sample statistical amount may include a mean, a standard deviation, a mode, a median, etc., of the second probability distribution. However, this is just an example for the second sample statistical amount and the form of the second sample statistical amount is not limited thereto.

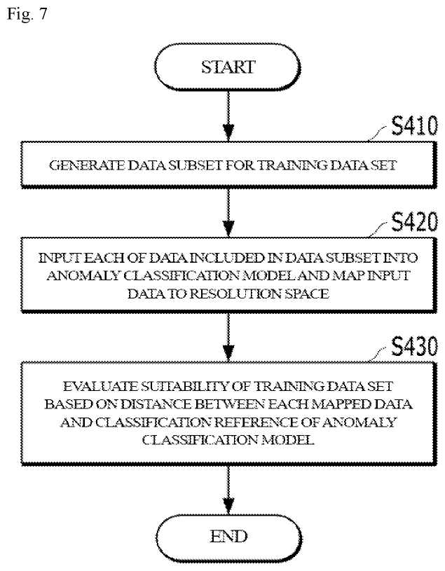

FIG. 7 is a flowchart illustrating a process of performing evaluation for a training data set by a processor according to some embodiments of the present disclosure.

Referring to FIG. 7, the processor 110 may generate a data subset for the training data set.

The data subset according to the present disclosure may be defined as a set of some data sampled from data included in the training data set.

The processor 110 may input each of the data included in the data subset into an anomaly classification model and the input data to a solution space (S420).

In the present disclosure, the resolution space may include a space in which data may be mapped to a representation in which predetermined processing for the input data is performed and for example, may include a space to which the data processed by the classification model may be mapped or a space to which a dimension reduction representation or the vector representation of the input data may be mapped. In the present disclosure, a data space may include a space to which the input data may be mapped.

The processor 110 may evaluate the suitability of the training data set based on a distance between each of the mapped data and the classification reference of the anomaly classification model (S430).

In the present disclosure, the evaluation of the suitability of the training data set may be based on a distance between each of the data included in the data subset and the classification reference.

For example, the processor 110 may calculate an average value of the distance between each of the data and the classification reference, and evaluate that the suitability of the training data set is lower as the average value of the distance decreases.

As another example, the processor 110 may calculate a dispersion index of the distance value between each data and the classification reference. Here, the dispersion index may be expressed as a distribution or standard deviation of the distance value. The processor 110 may evaluate the suitability of the training data set higher as the dispersion value is lower.

As still another example, the processor 110 may calculate the density of the training data included in the training data set.

In this case, for example, the processor 110 may calculate reciprocals of the average value of the distance, the dispersion, and the density as the suitability.

Since the aforementioned contents are just only an example of determining the suitability of the training data set, the method for calculating the suitability of the training data set is not limited thereto.

When evaluation for the plurality of training data sets is performed, the processor 110 may finally generate the training data set by using a sample statistical amount associated with the training data set with the highest suitability and a pseudo anomaly generation model that generates a probability distribution related thereto.

The closer the data is to the classification reference, the more helpful it is to train the classification reference of the neural network. Therefore, if the data included in an arbitrary data set are close to the classification reference on average, the data set may be suitable for learning the neural network. In addition, when comparing two data sets having an average distance of substantially the same range, a case where the data are dense may be a case suitable for learning the classification reference. The reason is that when the data are distributed over a wide range, learning may be difficult because the classification reference is ambiguous.

Accordingly, when the suitability of the training data set is determined based on the distance from the classification reference of the data included in the subset, the dispersion of the distance, and the density of the training data, it is possible to effectively evaluate the suitability of the training data set.

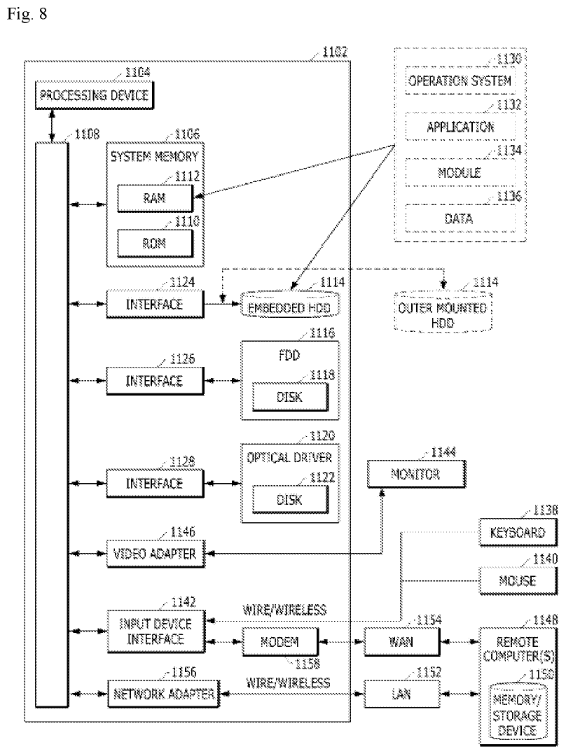

FIG. 8 is a simple and normal schematic view of a computing environment in which the embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, temporary and non-temporary media, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is used as an example and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various logical blocks, modules, processors, means, circuits, and algorithm steps described in association with the embodiments disclosed herein may be implemented by electronic hardware, various types of programs or design codes (for easy description, herein, designated as software), or a combination of all of them. In order to clearly describe the intercompatibility of the hardware and the software, various components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, an apparatus, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be interpreted within the widest range which is coherent with the principles and new features presented herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A non-transitory computer readable medium storing a computer program, wherein the computer program comprises instructions for causing one or more processors of a computing device to perform a method for data processing, the method comprising:
calculating a first probability distribution and a first sample statistical amount for a first sample data set by using the first sample data set;
training a pseudo anomaly generation model that learns a second probability distribution and a second sample statistical amount for a second sample data set; and
generating a training data set based on the pseudo anomaly generation model.

2. The non-transitory computer readable medium of claim 1, wherein the first sample data set and the second sample data set are vectors or scalars for homogenous data.

3. The non-transitory computer readable medium of claim 1, wherein the training of the pseudo anomaly generation model includes:
calculating an inter-distribution similarity between the first probability distribution and the second probability distribution, and
determining whether to additionally perform the training of the pseudo anomaly generation model based on the inter-distribution similarity.

4. The non-transitory computer readable medium of claim 3, wherein the determining of whether to additionally perform the training of the pseudo anomaly generation model based on the inter-distribution similarity includes determining to additionally perform the training of the pseudo anomaly generation model when the inter-distribution similarity is equal to or less than a preset first reference.

5. The non-transitory computer readable medium of claim 3, the method further comprising:
determining to terminate the training of the pseudo anomaly generation model when the inter-distribution similarity is equal to or more than the preset first reference; and
determining a sample statistical amount of a probability distribution derived from the pseudo anomaly generation model for which training is terminated as the second sample statistical amount.

6. The non-transitory computer readable medium of claim 1, wherein the training of the pseudo anomaly generation model includes:
determining a candidate sample statistical amount, and
determining the candidate sample statistical amount as the second sample statistical amount based on a significance probability of at least one data value of data values included in the candidate sample statistical amount.

7. The non-transitory computer readable medium of claim 6, wherein the candidate sample statistical amount is determined based on extracted noise and the first sample statistical amount.

8. The non-transitory computer readable medium of claim 7, wherein the noise is extracted from a normal distribution.

9. The non-transitory computer readable medium of claim 6, wherein the determining of the second sample statistical amount includes determining the candidate sample statistical amount as the second sample statistical amount when the significance probability of a first data value included in the candidate sample statistical amount exceeds a preset reference.

10. The non-transitory computer readable medium of claim 1, wherein
the first sample data set and the training data set include time-series data, and
the pseudo anomaly generation model is a neural network that can process the time series data.

11. The non-transitory computer readable medium of claim 1, the method further comprising:
performing the evaluation for the training data set.

12. The non-transitory computer readable medium of claim 11, wherein the performing of the evaluation for the training data set includes:
generating a data subset for the training data set,
inputting each of the data included in the data subset into the anomaly classification model and mapping the input data to a resolution space, and
calculating suitability of the training data set based on the data included in the data subset and a classification reference of the anomaly classification model.

13. The non-transitory computer readable medium of claim 12, wherein the suitability is based on at least one of: a distance of each of the data included in the training data set from the classification reference, a ratio of anomalous data of the training data set, density of the data included in the training data set, or a dispersion of a distance of each of the data included in the training data set from the classification reference.

14. The non-transitory computer readable medium of claim 12, wherein the suitability is a reciprocal of at least one of: a distance of each of the data included in the training data set from the classification reference, a ratio of anomalous data of the training data set, density of the data included in the training data set, or a dispersion of a distance of each of the data included in the training data set from the classification reference.

15. A computing device for data processing, comprising:
a processor; and
a memory,
wherein the processor is configured to:
calculate a first probability distribution and a first sample statistical amount for first sample data,
train a pseudo anomaly generation model that learns a second probability distribution and a second sample statistical amount for a second sample data set, and
generate a training data set based on the pseudo anomaly generation model.

16. A method for generating pseudo anomaly performed by one or more processors of a computer device, the method comprising:
calculating a first probability distribution and a first sample statistical amount for a first sample data set by using the first sample data set;
training a pseudo anomaly generation model that learns a second probability distribution and a second sample statistical amount for a second sample data set; and
generating a training data set based on the pseudo anomaly generation model.
